(19) United States
(12) Patent Application Publication
(10) Pub. No.: US 2021/0256880 A1
(43) Pub. Date: Aug. 19, 2021

(54) LABEL FOR A CONTAINER HOLDER

(71) Applicant: Michael R. Kennedy, Gates Mills, OH (US)

(72) Inventor: Michael R. Kennedy, Gates Mills, OH (US)

(21) Appl. No.: 16/792,524

(22) Filed: Feb. 17, 2020

(51) Int. Cl. G09F 3/10; B65D 71/50; G09F 3/02

(52) U.S. Cl. CPC G09F 3/10; B65D 71/504; G09F 3/02; G09F 2003/0273; G09F 2003/0208; G09F 2003/0241; B65D 2203/02

(57) ABSTRACT

A label is provided for displaying product, marketing or other indicia or messaging on a container holder configured to secure a plurality of containers together. The label spans at least two clamp elements of the container holder to provide a platform for presenting the aforementioned indicia, and can be adhered to respective upper surfaces of those clamp elements. A container assembly having such a label, such as a six-pack of beverage cans, also is disclosed.

### BACKGROUND OF THE INVENTION

### 1. Field of the Invention

This application relates generally to a label having advertisement or other indicia thereon and, more specifically, to a label for a container holder configured to secure a plurality of containers together.

### 2. Description of Related Art

Due to environmental considerations, beverage manufactures (e.g., soda, seltzer, beer, etc.) are moving away from conventional six-pack plastic rings (also called yokes) to connect together containers (e.g., beverage cans) for transport and/or distribution. New six-pack holders have been introduced and are now being used to secure together a plurality of beverage cans to yield a six-pack. Such new holders have individual clamp elements that are adapted to clamp respective cans by interacting with an upper metal lip or rim on each can. The clamp elements typically are connected together and arranged in a 2×3 array as seen in FIG. 4, in order to secure together an otherwise conventional six-pack of beverage cans; of beer, for example. It will be desirable to contrive a label useful to affix to upper portions of the aforementioned clamp elements, in order to enhance the surface area available to display product and/or marketing indicia thereon.

### BRIEF SUMMARY

In accordance with one aspect, there is provided a label for displaying indicia on a container holder configured to secure a plurality of containers together. The label has first and second opposing end portions and an intermediate portion disposed between and connecting the first and second opposing end portions. The first and second opposing end portions are mirror-image shapes of one another relative to an imaginary transverse axis bisecting the label. The intermediate portion has a transverse dimension along the transverse axis that is smaller than respective transverse dimensions of the first and second opposing end portions.

A pressure-sensitive adhesive coating can be applied to an underside surface of the label on the first and second opposing end portions thereof. The first and second opposing end portions and the intermediate portion all can be formed integrally and thereby define a continuous, uninterrupted upper surface of the label that spans the first and second opposing end portions and the intermediate portion thereof, such that the indicia printed thereon can span the first and second opposing end portions as well as said intermediate portion.

In accordance with another aspect, there is provided a container assembly including a container holder having a first clamp element configured to be secured to a first container, and a second clamp element adjacent and connected to the first clamp element and configured to be secured to a second container. The container assembly further includes a label having first and second end portions opposing one another relative to a longitudinal axis of the label, and an intermediate portion extending along the longitudinal axis and disposed between and connecting the first and second end portions.

The intermediate portion has a transverse dimension perpendicular to the longitudinal axis that is smaller than respective transverse dimensions of the first and second end portions also perpendicular to the longitudinal axis. The first and second end portions of the label can be adhered to upper surfaces of the first and second clamp elements, respectively, such that the intermediate portion spans a distance between the first and second clamp elements and is unadhered to the container holder.

In accordance with yet another aspect, there is provided a six-pack of beverage cans including a can holder having six clamp elements arranged in a 2×3 matrix with each one of the respective clamp elements being connected to at least two adjacent ones of the clamp elements via intermediate bridge members. The six-pack of beverage cans further includes six beverage cans secured respectively at underside surfaces of each of the six clamp elements.

In a further aspect, a label can have first and second opposing end portions and an intermediate portion disposed between and connecting the first and second opposing end portions. The first and second opposing end portions can be adhered respectively to upper surfaces of a pair of adjacent ones of the clamp elements. The intermediate portion of the label spans a distance between the adjacent clamp elements and overlying, but not contacting, the respective bridge member connecting the adjacent clamp elements. Indicia can be printed on an upper surface of the label.

### BRIEF DESCRIPTION OF THE DRAWINGS

FIG. 1 is a top view of a label for a container holder;

FIG. 2A is a cross-sectional view of the label shown in FIG. 1, taken along the line 2-2, according to a first embodiment;

FIG. 2B is an alternative cross-sectional view of the label shown in FIG. 1, taken along the line 2-2, according to a second embodiment;

FIG. 3A is a bottom view of the label shown in FIG. 1 according to the first embodiment;

FIG. 3B is a bottom view as in FIG. 3A, utilizing an edge-recessed adhesive pattern instead of the edge-to-edge adhesive pattern used in FIG. 3A;

FIG. 4 is a perspective view of a container holder having containers, such as beverage cans, secured to respective clamp elements thereof to form a six-pack (only two such containers are illustrated);

FIG. 5 is a top view of the container holder shown in FIG. 4 with the label shown in FIG. 1 disposed on and bridging adjacent clamp elements thereof;

FIG. 6A is a cross-sectional view of one of the clamping elements of the container holder shown in FIG. 5, taken along the line 6-6 and having a label affixed to an upper surface thereof;

FIG. 6B is a cross-sectional view of the container holder shown in FIG. 5, with an alternative embodiment of the label affixed thereto;

FIG. 6C is a cross-sectional view of the container holder shown in FIG. 5, with yet another alternative embodiment of the label affixed thereto;

FIG. 7 is a top view of a first alternative embodiment of a label to be affixed to and span two adjacent clamp elements of the container holder of FIG. 4;

FIG. 8 is a top view of a second alternative embodiment of a label to be affixed to and span two adjacent clamp elements of the container holder of FIG. 4;

FIG. 9 is a top view of a third alternative embodiment of a label to be affixed to and span two adjacent clamp elements of the container holder of FIG. 4;

FIG. 10 is a top view of a fourth alternative embodiment of a label to be affixed to and span two adjacent clamp elements of the container holder of FIG. 4;

FIG. 11 is a top view of a fifth alternative embodiment of a label to be affixed to and span two adjacent clamp elements of the container holder of FIG. 4;

FIG. 12 is a top view of a sixth alternative embodiment of a label to be affixed to and span two adjacent clamp elements of the container holder of FIG. 4;

FIG. 13 is a top view of a seventh alternative embodiment of a label to be affixed to and span two adjacent clamp elements of the container holder of FIG. 4;

FIG. 14 is a top view of an eighth alternative embodiment of a label to be affixed to and span two adjacent clamp elements of the container holder of FIG. 4;

FIG. 15 is a top view of a ninth alternative embodiment of a label to be affixed to and span two adjacent clamp elements of the container holder of FIG. 4; and

FIG. 16 is a top view of a tenth alternative embodiment of a label to be affixed to a clamp element of the container holder of FIG. 4.

### DETAILED DESCRIPTION

Relative language used herein is best understood with reference to the drawings, in which like numerals are used to identify like or similar items or features.

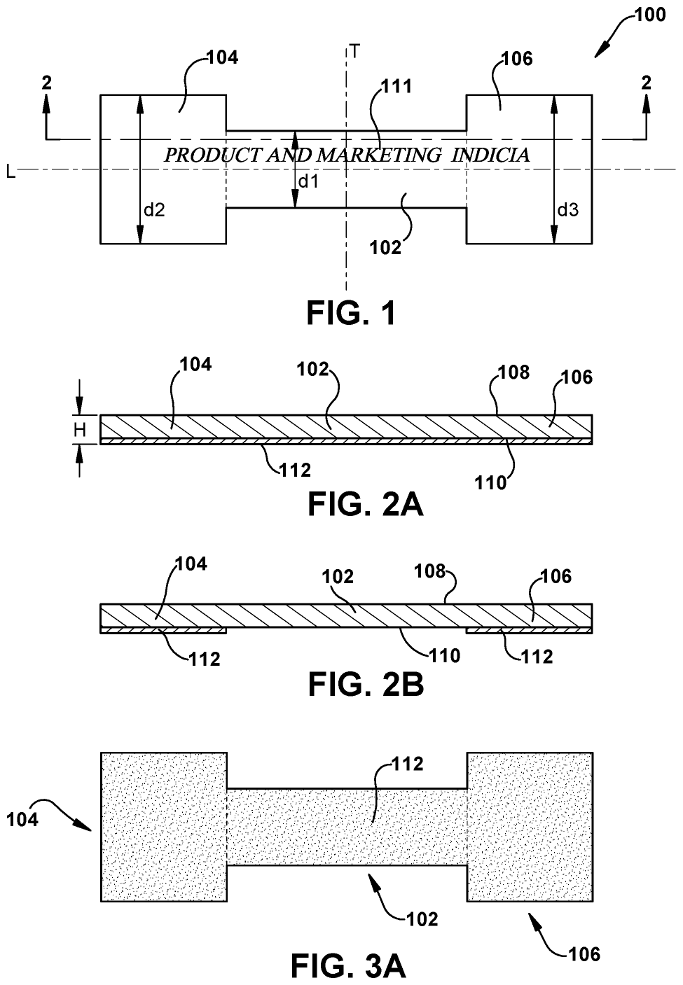

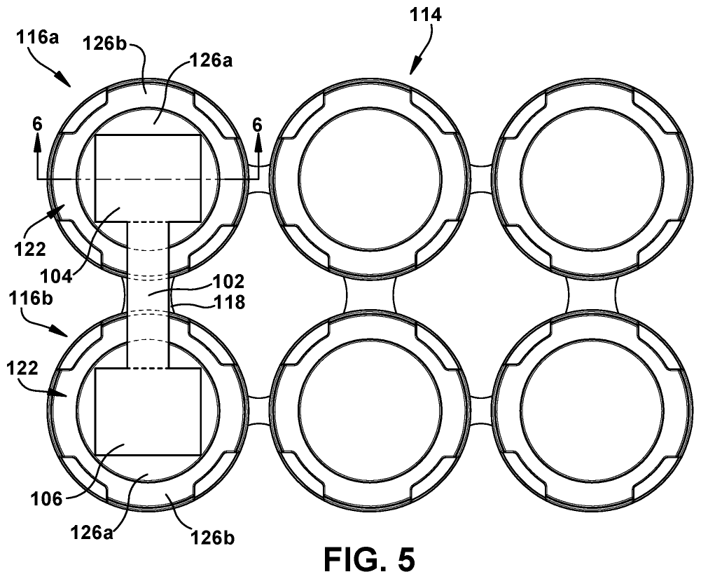

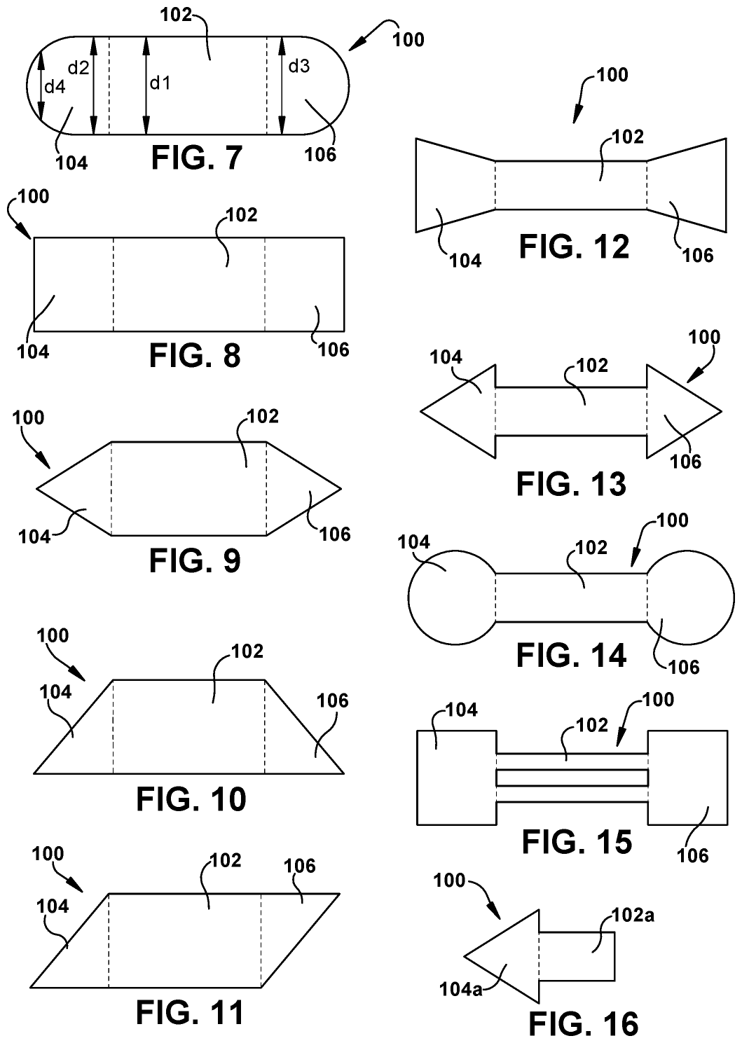

Referring now to the drawings, FIG. 1 depicts one example of a label 100 configured to be affixed to and span adjacent clamp elements of a container holder 114 as shown in FIGS. 4-5, discussed above, and further below. As will be further detailed below, FIGS. 7-16 depict alternative, further example embodiments of such a label 100 having different shapes, geometries, etc. It is to be understood that the label 100 may have any shape, configuration, dimensions, etc., so long as the label 100 is adapted to be affixed to adjacent clamp elements of a container holder 114 as herein described, such that a portion thereof bridges a space between those clamping elements as detailed below.

As shown in FIG. 1, the label 100 includes first and second opposing end portions 104, 106 (relative to a longitudinal axis L of the label), and an intermediate portion 102 extending between the first and second end portions 104, 106 along the longitudinal axis L. Preferably the first and second end portions 104, 106 and the intermediate portion 102 present an uninterrupted, continuous upper surface for the printing and display of indicia thereon. Because the upper surface is continuous, the aforementioned indicia optionally can span two or more of the first and second end portions 104, 106 and the intermediate portion 102 in a continuous manner and without interruption or breaks. In the embodiment of FIG. 1, the first and second end portions 104, 106 are substantially rectangular or square and are mirror-images of one another, while the intermediate portion 102 also is rectangular.

As used herein, ‘indicia’ refers to any matter that is printed or otherwise applied to an upper surface of a label as herein described. Indicia can include numeric or text characters, images, logos, graphics, and/or any and all other visually perceptible elements or features, whether or not such elements or features convey messaging or information to an observer, and including without limitation background features such as, e.g., a solid- or variable-color or texture background, or any other background that is printed or otherwise applied in order to provide a contrasting appearance with respect to other indicia also applied, either with or on top of the background.

As best shown in FIG. 2A, the label 100 has an upper surface 108 and an opposing underside surface 110. The upper and underside surfaces 108, 110 are spaced from one another in a direction normal to the longitudinal axis L of the label 100 by a height H (i.e., thickness) of the label 100. In the illustrated embodiments, the height H of the label 100 is constant across the entire label 100 along its longitudinal axis L. But this is not required. For example, various portions of the label 100 can have different heights.

As seen in FIG. 1, product-, marketing- or other indicia 111 are disposed on the upper surface 108 of the label 100. The indicia 111 can include symbols, numbers, letters, words, barcodes, designs, backgrounds, coloring, etc., or any combination thereof, and may present advertising or marketing messages or information, or messages or information on any topic and for any purpose. As noted above, the indicia 111 can be disposed on the upper surface 108 of the label 100 such that it spans the label 100 along its longitudinal axis L, from the first end portion 104 through the intermediate portion 102 and to the second end portion 106.

It is to be understood that the first and second end portions 104, 106 and the intermediate portion 102 are all formed integrally, as a single common label such that the upper surface 108 thereof will be a single, continuous surface as already explained. In this manner, the label 100 is configured to maximize the surface area available for printing indicia 111 to be displayed on the container holder 114, regardless of the shape of the particular label 100 and its specific first and second end portions 104, 106 and intermediate portion 102, which can vary.

In the embodiment of FIG. 1, the first and second end portions 104, 106 have the same general shape and are mirror-images of one another relative to an imaginary transverse centerline axis T, which is coplanar with and perpendicular to the longitudinal axis L. However, the first and second end portions 104, 106 need not have mirror-image shapes, nor the same shape.

In the embodiment shown in FIG. 1, the intermediate portion 102 is dimensioned such that a transverse width thereof, (i.e., taken along the transverse axis T) is smaller than comparable, parallel dimensions of the first and second end portions 104, 106. For example, the intermediate portion 102 has a width d1, the first end portion 104 has a width d2, and the second end portion 106 has a width d3. The widths d2, d3 of the first and second end portions 104, 106, respectively, can be constant and equal, as shown in FIG. 1, and the width d1 of the intermediate portion 102 can be smaller than the widths d2 and d3. But as will be further detailed below, the width d1 of the intermediate portion 102 need not be smaller than the widths d2, d3 of the first and second end portions 104, 106, respectively.

Referring to FIG. 2A, a pressure-sensitive adhesive coating 112 is disposed on the underside surface 110 of the label 100 in order that the label 100 may be adhered to adjacent clamp elements of the container holder 114 as hereafter described. The pressure-sensitive adhesive coating 112 may be any suitable pressure-sensitive adhesive, and its composition is not critical to the invention described here. In the embodiment of FIG. 2A, the pressure-sensitive adhesive coating 112 is provided over the entire underside surface 110 of the label 100 spanning the first end portion 104, the intermediate portion 102, and the second end portion 106 as a continuous coating layer. In an alternative embodiment depicted in FIG. 2B, the pressure-sensitive adhesive coating 112 can be provided on the underside surface 110 of the label 100 only in the first and second end portions 104, 106 thereof. That is, if desired the underside surface 110 of the label 100 can be devoid of any adhesive coating in the intermediate portion 102 of the label 100.

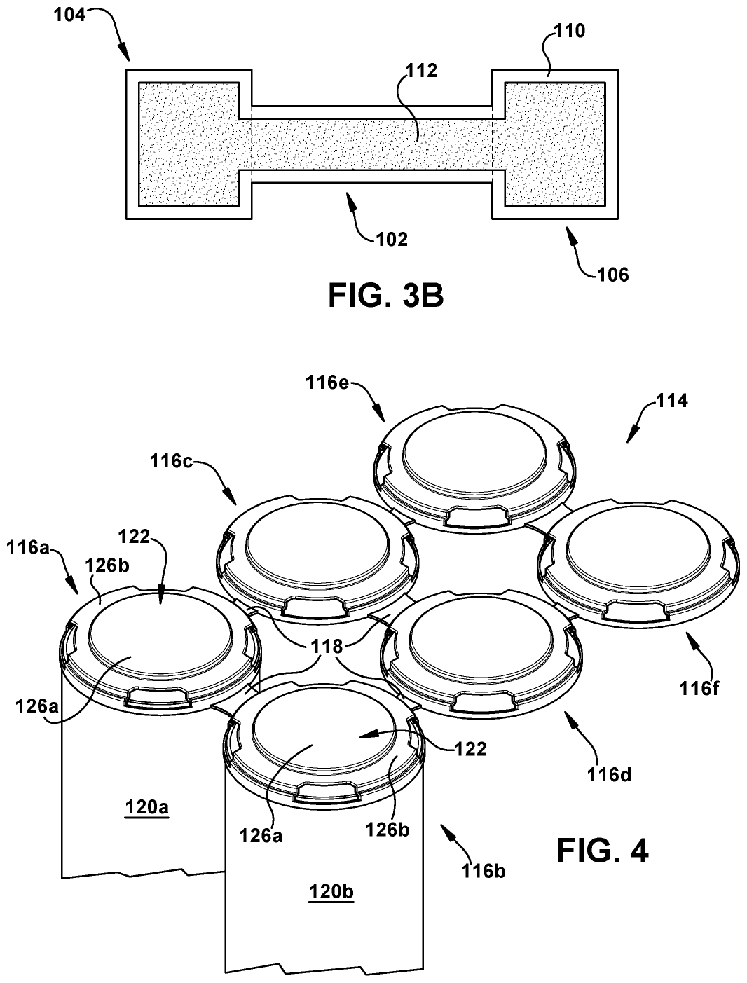

As seen in FIGS. 2A and 3A, the pressure-sensitive adhesive coating 112 can be applied over the entire underside surface 110 of the label 100, up to the perimeter edge of that label 100. However, as shown in FIG. 3B, the pressure-sensitive adhesive coating 112 also can be applied so that it does not extend all the way to the perimeter edge of the label 100, but rather is recessed from that edge, e.g. about its entire perimeter, leaving an uncoated lip of the underside surface 110 of the label 100 at its perimeter. This uncoated lip can extend about the entire perimeter of the underside surface 110 as shown in FIG. 3B, or it may be along only a portion of that perimeter; e.g. at or adjacent outer ends of one or both of the first and second end portions 104, 106. An uncoated lip portion as here described may assist in removal of the label 100, if desirable, from the container holder 114 by enabling a user to easily grasp the uncoated lip portion and pulling the label 100.

Note that an uncoated lip portion as described above can be disposed about the perimeter (or part thereof) of one or both of the first and second end portions 104, 106 of the label 100, even if the intermediate portion 102 is devoid of any adhesive coating (as depicted in FIG. 2B).

In further alternatives, not shown, the pressure-sensitive adhesive coating 112 can completely fill (i.e. provide edge-to-edge coverage over) an area of the underside surface 110 of only one of the first and second end portions 104, 106, but not necessarily both, with or without coverage of the intermediate portion 102.

As briefly mentioned above, the label 100 is configured to be disposed on a container holder 114. With respect to FIG. 4, such a container holder 114 includes a plurality of clamp elements 116a-116f aligned and attached to one another in a matrix. Each such clamp element 116a-116f is configured to be secured (e.g., snap-fit) to a top of a container (e.g., beverage container, food container, cosmetic container, etc.), such as a conventional beverage can. In this manner, the container holder 114 collectively secures a plurality of such containers (e.g. beverage cans) together for efficient transportation and distribution. In the illustrated embodiment, the container holder 114 is configured as a six-pack beverage-can holder in order to hold together and transport six beverage cans together in a 2×3 matrix, each being secured to a respective clamp element 116a-116f, to yield a traditional six-pack of cans. However, the container holder 114 is not limited to this 2×3 matrix, and can include any number of clamp elements attached to one another in other-dimensioned matrices (e.g., less than or greater than six).

In the illustrated embodiment, each of the clamp elements 116a-116f is connected to adjacent clamp elements via respective bridge members 118 extending therebetween. These bridge members 118 may be formed integrally with the clamp elements 116a-116f, such as when the entire container holder 114 is formed from a moldable plastic material as a single-piece part. Alternatively, the bridge members 118 can be separately formed and attached to the clamp elements 116a-116f to yield the desired matrix thereof for a particular container holder 114.

It is to be understood that each of the plurality of clamp elements 116a-116f can have substantially the same design and/or configuration. For brevity, the below discussion relates primarily to only the first and second clamp elements 116a, 116b of container holder 114, understanding that similar descriptions will apply to other adjacent pairs of the clamp elements (e.g., 116c-116f).

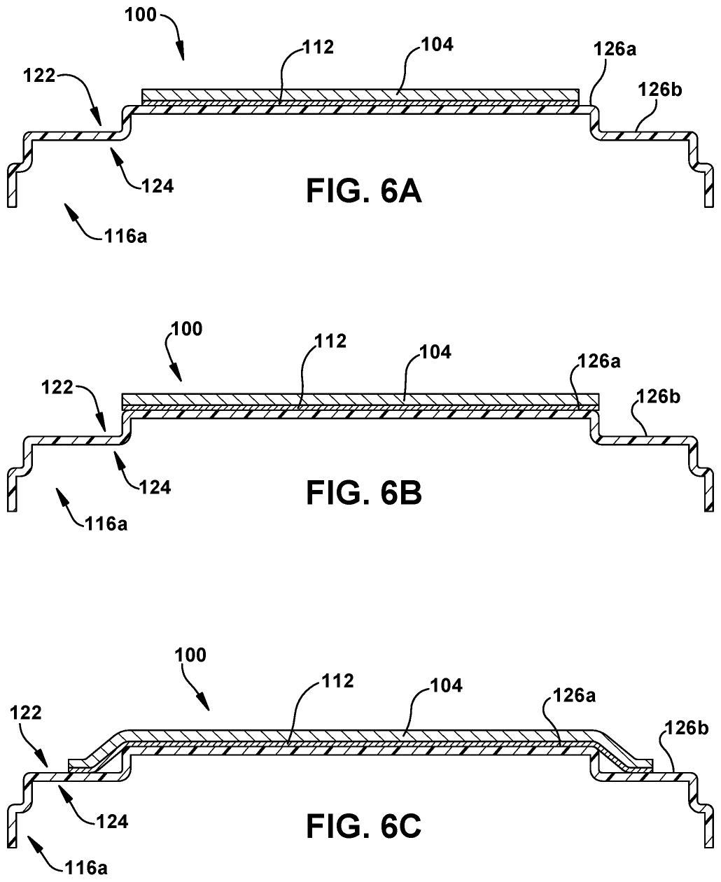

As shown, the first and second clamp elements 116a, 116b are secured (e.g., snap-fit) to tops of first and second containers 120a, 120b, respectively. Each of the first and second clamp elements 116a, 116b includes an upper surface 122 and an opposing underside surface 124 (best seen in FIGS. 6A-6C). As will be appreciated, the upper surface 122 faces outwards and away from the container (e.g. beverage can) secured to the clamp element at the underside of that element.

Now referring to the first clamp element 116a (and understanding that a similar description applies to other clamp elements), the upper surface 122 thereof can include a first, central region 126a standing proud of a second, perimeter region 126b, which are concentric and circular in the illustrated embodiment. However, it is to be understood that the first and second regions 126a, 126b need not be circular or concentric. For example, the first and second regions 126a, 126b can have any other geometric configuration (e.g., concentric squares, rectangles, triangles, etc.), and may be disposed side-by-side, etc. It also should be noted that the first and second regions 126a, 126b need not be at different elevations, but rather can be at the same elevation, and can constitute a continuous, flat upper surface 122.

Moving on to FIG. 5, the label 100 (embodiment shown in FIG. 1) is disposed on the container holder 114, specifically on the first and second adjacent clamp elements 116a, 116b thereof. However, it is to be understood that the label 100 can be disposed on any adjacent pair of the clamp elements 116a-116f.

The label 100 is disposed on the container holder 114 such that the first end portion 104 is applied on the first clamp element 116a and the second end portion 106 is applied on the second clamp element 116b, with the intermediate portion 102 spanning the space between them, over the associated bridge member 118. Specifically, the first and second end portions 104, 106 are secured to the upper surfaces 122 of the first and second clamp elements 116a, 116b, respectively, via the pressure-sensitive adhesive coating 112 (not shown in FIG. 5). While the intermediate portion 102 may also have the adhesive coating 112 on its underside surface 110, typically that portion (i.e., the intermediate portion 102) will not be adhered to any part of the container holder 114, and instead will remain unaffixed over the bridge member 118, without being in contact therewith. Alternatively, the intermediate portion 102 may contact the bridge member 118 and may be adhered thereto if its underside surface 110 has the pressure-sensitive adhesive coating 112 thereon.

With respect to FIG. 6A, a cross-sectional view of a first or second end portion 104, 106 of the label 100 applied to a clamp element 116a-116f of the container holder 114 is shown. Specifically, the depicted embodiment is a cross-sectional view of the first end portion 104 of the label 100 applied to the first clamp element 116a of the container holder 114. However, the ensuing discussion (and the figure) may refer to any clamp element of the container holder 114. As mentioned above, the underside surface 124 of the first clamp element 116a faces toward the container (beverage can) that will be secured thereto in-use. In this manner, when the first clamp element 116a is secured to a container (e.g. the first container 120a) the upper surface 122 thereof faces upward.

In the illustrated embodiment, the label 100 is disposed on the container holder 114 such that the pressure-sensitive adhesive coating 112 secures the first end portion 104 of the label 100 to the first, central region 126a of the upper surface 122 of the first clamp element 116a. Separately, the second end portion 106 of the label 100 is secured to the first, central region 126a of the upper surface 122 of the second (adjacent) clamp element 116b. In the depicted embodiment (FIG. 6A), the first end portion 104 of the label 100 is dimensioned to not completely (i.e. edge-to-edge) fill the first region 126a of the upper surface 122. Rather, it is dimensioned so as to be recessed inward from the perimeter of the first region 126a. Moreover, in this embodiment the entire second, perimeter region 126b of the upper surface 122 is not covered (i.e., exposed) by the label 100.

In an alternative embodiment depicted in FIG. 6B, the first end portion 104 of the label 100 is dimensioned so as to provide complete, end-to-end coverage of the first, central region 126a of the upper surface 122. In other words, the first end portion 104 is shaped and dimensioned to substantially correspond to the shape of the first region 126a, but still leaving the entire second region 126b of the upper surface 122 not covered (i.e., exposed) by the label 100.

In yet another embodiment depicted in FIG. 6C, the first end portion 104 of the label 100 is dimensioned and disposed on the first clamp element 116a such that it covers respective areas of both the first and second regions 126a, 126b of the upper surface 122. For example, the first end portion 104 can cover the entire area of the first region 126a while only covering a portion of the area of the second region 126b. In another example, the first end portion 104 can cover only a portion of the respective areas of the first and second regions 126a, 126b. In yet a further example, the first end portion 104 can cover only a portion of the area of the first region 126a, while covering the entire area of the second region 126b (e.g. if there is a cutout or hole in the label 100 at the center of the first end portion 104—not shown).

The second end portion 106 can conform to the description given above for the first end portion 104 of a particular label 100, thus covering a second, adjacent clamp element 116b in substantially the same manner. The first and second end portions 104, 106 of a particular label 100 can be the same, thus providing similar coverage over the respective first and second clamp elements 116a, 116b when applied thereto. However, the first and second end portions 104, 106 also can be different, providing different coverage of the respective first and second clamp elements 116a, 116b, for example according to the embodiments previously described. For example, the first end portion 104 can cover the first clamp element 116a in the manner depicted in FIG. 6A, while the second end portion 106 covers the second clamp element 116b in the manner depicted in FIG. 6B or 6C.

Moving now to FIGS. 7-16, alternative embodiments of the label 100 are shown. With respect to FIG. 7, the label 100 is shown as having a stretched oval shape. Specifically, the first and second end portions 104 and 106 each have a peripheral surface that is curved to provide the stretched oval shape of the label 100. In the depicted embodiment, the first and second end portions 104, 106 are mirror-images of one another, and the intermediate portion 102 has the same, common width as the greatest width of the end portions 104, 106. That is, the width d1 of the intermediate portion 102 is equal to the greatest width d2, d3 of each of the end portions 104 and 106. Note, however, in this embodiment, a width d4 of each end portion 104, 106 becomes smaller beginning at a point moving laterally outward from the center and continuing until the lateral edge of the label 100, corresponding to the substantially circular lateral edge of each such end portion 104, 106.

FIGS. 8-15 illustrate further alternative embodiments, wherein the first and second end portions 104, 106 of a particular label 100 can conform to different shapes, which may (but need not) be mirror-images of one another, and which may (but need not) even be the same shape. For example, in the embodiments of FIGS. 7-10 and 12-15, the respective first and second end portions 104, 106 are mirror-image shapes of one another. Whereas in the embodiment of FIG. 11, although the first and second end portions 104, 106 are the same shape they are not mirror-images; rather one has been rotated relative to the other. It is to be further noted that although all the illustrated embodiments depict end portions having common shapes, that also need not be the case. That is, a rectangular-shaped end portion such as in FIG. 8 could be combined with a triangular, trapezoidal or circular end-portion as in any of FIG. 9, 12 or 14 to yield an asymmetrical label 100 having differently configured first and second end portions 104, 106. Moreover, as seen in FIG. 15, the intermediate portion 102 also need not be a continuous single portion of the label 100. Instead, it may be a plurality of portions of the label 100 that cooperate to connect the first and second end portions 104, 106 to form the label 100.

As mentioned above, the label 100 is not limited to having any of the aforementioned shapes or relative dimensions, all of which are optional and none of which is critical to the invention here. That is, the first and second end portions 104, 106 of a particular label 100 can have any shape, including geometric shapes, symbols, characters, etc. All that is relevant here is that at least one of the first and second end portions 104, 106 of the label 100 can be adhered to the respective upper surface(s) 122 of adjacent clamp elements 116a-116f of a container holder 114 via adhesive coatings 112 in order to display messaging or other indicia 111 on the upper surface 108 of the label 100. Likewise, while the intermediate portion 102 is depicted in each of the embodiments as having a generally rectangular shape, the general shape of the intermediate portion 102 also is not critical or limited and can have any shape so long as it connects the first and second end portions 104, 106.

In a further embodiment shown in FIG. 16, a label 100 as contemplated herein can include only one major portion 104a configured to be adhered to the upper surface 122 of a clamp element 116a-116f of a container holder 114, wherein a tail portion 102a of the label 100 extends from the major portion 104a and is free and unattached in-use. In this embodiment, the tail portion 102a may serve as a tab for easy removal of the label 100, which in this embodiment is adhered only to a single clamp element 116, e.g. of a six-pack container holder 114. In this embodiment, the major portion 104a can be configured similarly as the first and second end portions 104, 106 of labels in other embodiments as herein disclosed, and the tail portion 102a can be similarly configured as the intermediate portion 102 in those other embodiments. Here, the major portion 104a and associated tail portion 102a constitute a single label 100, preferably having a single, common upper surface 108 as in the other embodiments for providing messaging or other indicia 111.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A label for displaying indicia on a container holder configured to secure a plurality of containers together, the label comprising:
first and second opposing end portions and an intermediate portion disposed between and connecting the first and second opposing end portions, said first and second opposing end portions being mirror-image shapes of one another relative to an imaginary transverse axis bisecting said label, the intermediate portion having a transverse dimension along said transverse axis that is smaller than respective transverse dimensions of the first and second opposing end portions; and
a pressure-sensitive adhesive coating applied to an underside surface of said label on the first and second opposing end portions thereof;
the first and second opposing end portions and the intermediate portion all being formed integrally and thereby defining a continuous, uninterrupted upper surface of said label that spans the first and second opposing end portions and the intermediate portion thereof, such that indicia printed thereon can span said first and second opposing end portions as well as said intermediate portion.

2. The label according to claim 1, wherein the underside surface of said label being devoid of said pressure-sensitive adhesive coating in the intermediate portion thereof.

3. The label according to claim 1, the pressure-sensitive adhesive coating being applied edge-to-edge on said underside surface in the first end portion of the label.

4. The label according to claim 3, the pressure-sensitive adhesive coating being applied edge-to-edge on said underside surface in the second end portion of the label.

5. The label according to claim 1, the pressure-sensitive adhesive coating being applied edge-to-edge on the entire underside surface of the label.

6. A container assembly comprising:
a container holder comprising a first clamp element configured to be secured to a first container, and a second clamp element adjacent and connected to the first clamp element and configured to be secured to a second container; and
a label comprising first and second end portions opposing one another relative to a longitudinal axis of the label, and an intermediate portion extending along said longitudinal axis and disposed between and connecting the first and second end portions, wherein the intermediate portion has a transverse dimension perpendicular to said longitudinal axis that is smaller than respective transverse dimensions of the first and second end portions also perpendicular to said longitudinal axis;
the first and second end portions of said label being adhered to upper surfaces of the first and second clamp elements, respectively, such that said intermediate portion spans a distance between said first and second clamp elements and is unadhered to said container holder.

7. The container assembly according to claim 6, said label further comprising a pressure-sensitive adhesive coating applied to an underside surface thereof in each of said first and second end portions, said first and second end portions thus being adhered to the respective upper surfaces of said first and second clamp elements via said pressure-sensitive adhesive coating.

8. The container assembly according to claim 7, said pressure-sensitive adhesive coating being further applied to said underside surface of said label in said intermediate portion thereof.

9. The container assembly according to claim 6, the upper surface of the first clamp element comprising a first, central region and a second, perimeter region, the first, central region standing proud of the second, perimeter region, said first end portion of said label being applied only to said first, central region of said first clamp element and not to said second, perimeter region thereof.

10. The container assembly according to claim 9, the upper surface of said second clamp element also having a first, central region standing proud of a second, perimeter region thereof, said second end portion of said label being applied only to said first, central region of said second clamp element and not to said second, perimeter region thereof.

11. The container assembly according to claim 6, the first and second clamp elements being connected to one another by a bridge member, the intermediate portion of said label extending over but not contacting the bridge member.

12. The container assembly according to claim 6, said container holder comprising six total clamp elements arranged in a 2×3 matrix and adapted to secure respective beverage cans thereto in order to yield a six-pack of said cans.

13. The container assembly according to claim 6, said first and second clamp elements being secured respectively to first and second containers in order to join said cans in a pack for transport.

14. The container assembly according to claim 13, said first and second containers being first and second beverage cans, respectively.

15. A six-pack of beverage cans comprising:
a can holder comprising six clamp elements arranged in a 2×3 matrix with each one of the respective clamp elements being connected to at least two adjacent ones of said clamp elements via intermediate bridge members;
six beverage cans secured respectively at underside surfaces of each of the six clamp elements;
a label comprising first and second opposing end portions and an intermediate portion disposed between and connecting the first and second opposing end portions, said first and second opposing end portions being adhered respectively to upper surfaces of a pair of adjacent ones of said clamp elements, said intermediate portion of said label spanning a distance between the adjacent clamp elements and overlying, but not contacting, the respective bridge member connecting the adjacent clamp elements; and
indicia printed on an upper surface of said label.

16. The six-pack according to claim 15, said upper surface of said label being continuous and uninterrupted, spanning said first and second opposing end portions and said intermediate portion therebetween, said indicia being printed continuously at least over said first end portion and said intermediate portion.

17. The six pack according to claim 15, said first and second opposing end portions being mirror-image shapes of one another relative to an imaginary transverse axis bisecting said label, said intermediate portion having a maximum transverse dimension along said transverse axis that is smaller than respective maximum transverse dimensions of the first and second opposing end portions.

18. The six pack according to claim 15, the upper surfaces of said pair of clamp elements respectively comprising a first, central region standing proud of a second, perimeter region thereof, said first and second opposing end portions of said label being applied only to the respective first, central regions of said pair of clamp elements and not to the respective second, perimeter regions thereof.
